(19) United States
(12) Patent Application Publication
(10) Pub. No.: US 2020/0378504 A1
(43) Pub. Date: Dec. 3, 2020

(54) 2/2 or 3/3 Directional Insert Valve, and Method for the Production Thereof

(71) Applicant: Robert Bosch GmbH, Stuttgart (DE)

(72) Inventors: Hubert Feser, Gemuenden (DE); Alexander Stroka, Partenstein (DE); Johannes Schnackig, Eussenheim (DE); Sebastian Vornwald, Wuerzburg (DE); Stefan Semrau, Laasdorf (DE); Tobias Schreier, Partenstein (DE); Udo Neuf, Partenstein (DE); Werner Zeh, Dorfprozelten (DE)

(21) Appl. No.: 16/884,738

(22) Filed: May 27, 2020

(30) Foreign Application Priority Data
May 29, 2019 (DE) 10 2019 207 949.0
Mar. 26, 2020 (DE) 10 2020 203 953.4

(51) Int. Cl. F16K 3/24; F16K 3/316

(52) U.S. Cl. CPC F16K 3/246; F16K 3/316

(57) ABSTRACT

A 2/2 directional insert valve includes a bushing that has, as a pressure medium passage, holes distributed on the circumference. Via the holes and an interior of the bushing, at least one annular duct at the outer circumference of the bushing is configured to be connected to a port on a face side of the bushing. The holes are configured to be closed off by a displaceable closing body. The holes are enlarged in a circumferential direction and are formed as elongate holes so as to minimize the throughflow resistance.

This application claims priority under 35 U.S.C. § 119 to patent application nos. DE 10 2019 207 949.0, filed on May 29, 2019 in Germany, and DE 10 2020 203 953.4, filed on Mar. 26, 2020 in Germany, the disclosures of which are incorporated herein by reference in their entirety.

### BACKGROUND

The disclosure relates to 2/2 and 3/3 directional insert valves, and to a method for the production thereof.

The applicant's data sheets RD 21010 (edition 2017-05), RD 21040/2017-05, and RD 21050/2003-02 have disclosed 2/2 directional insert valves which have a bushing which is inserted into an insert bore of a valve housing. In this case, an annular duct is formed in the insert bore so as to be interposed with respect to the bushing. A duct is arranged in the valve housing radially with respect to the bushing and opens into the annular duct. In the region of said annular duct, four or more circular holes or passage cutouts are provided, and separated from one another by webs, in the bushing. A movable closing body is received in the interior of the bushing. If said moving body is moved or pushed away from the passage cutouts, the passage cutouts are opened and a pressure medium connection between the annular duct and a face-side opening of the bushing is opened up.

A disadvantage of 2/2 directional insert valves of said type is the throughflow resistance thereof, which arises as a result of the relatively small passage cutouts and in particular as a result of the webs which are arranged between the passage cutouts.

### SUMMARY

By contrast, it is the object of the disclosure to provide a 2/2 and a 3/3 directional insert valve having a bushing and passage cutouts formed therein, wherein the throughflow resistance of the insert valve is reduced.

Said object is achieved by a 2/2 directional insert valve, or a 3/3 directional insert valve, having the features of Patent claim 1, and by a method for the production thereof having the features of Patent claim 14.

Further advantageous configurations of the disclosure are described in the dependent patent claims.

The claimed 2/2 and 3/3 directional insert valves have a bushing in which a closing body is guided. Passage cutouts are arranged in a circumferential direction of the bushing, preferably on a circular path. According to the disclosure, the passage cutouts are elongate holes which are larger (that is to say longer) in the circumferential direction of the bushing than in an axial direction of the bushing. In this way, a radial opening surface of the passage cutouts is maximized. In this way, the throughflow resistance of the passage cutouts and thus of the insert valve is reduced.

One exemplary embodiment involves a 3/3 directional insert valve whose closing body is a control slide. The bushing is then provided with a second group of passage cutouts, which are axially spaced apart from the first-mentioned passage cutouts. The passage cutouts of the second group are likewise arranged distributed in a circumferential direction of the bushing, preferably on a circular path. According to the disclosure, the passage cutouts of the second group are then also elongate holes which are larger in the circumferential direction of the bushing than in the axial direction of the bushing. In this way, a radial opening surface is maximized for the passage cutouts of the second group too. In this way, the throughflow resistance of the passage cutouts of the second group and thus of the insert valve is reduced for throughflow of the second group of elongate holes too.

In one refinement of the 3/3 directional insert valve, a first group of control cutouts and, axially spaced apart therefrom, a second group of control cutouts are arranged distributed on the control slide and, at least sectionally, are able to be brought into overlap with the elongate holes of the bushing. The control cutouts are particularly preferably likewise elongate holes which are larger in the circumferential direction of the control slide than in an axial direction of the control slide. In this way, the throughflow resistance of the passage cutouts of the second group and thus of the insert valve is reduced for throughflow of the second group of elongate holes too.

It is normally the case that webs remain between the elongate holes, which webs, according to one refinement of the disclosure, are reinforced in a radial direction in comparison with a guide region of the bushing that is closed over the full circumference. The guide region surrounds the closing body. The radial reinforcement is formed by way of an increase in the radial material thickness of the webs toward the outside in the direction of an annular duct. It is consequently possible to compensate for possible weakening of the webs as a result of the enlargement according to the disclosure of the passage cutouts.

In a preferred application of the disclosure, the insert valve is a seat valve, wherein the bushing has on the inner circumference a valve seat for the closing body. Advantageously, provision is then made for a reduction in the inner diameter of the bushing between the valve seat and a face-side opening of the bushing. The reduction in the inner diameter is to be understood in relation to the fully circumferential guide region of the bushing, in which guide region the closing body is guided. A thickening for increasing the strength in comparison with the fully circumferential guide region is consequently achieved.

If, as viewed in a circumferential direction, the webs extend over at most 25%, particularly preferably over at most 20%, of the outer circumference of the bushing, an optimal balance between strength of the bushing, on the one hand, and reduced throughflow resistance, on the other hand, is achieved.

In a preferred application of the disclosure, the bushing has on its outer circumference a radial step, or a further bushing is provided and forms a radial step with the bushing. By way of the radial step, an annular duct, at the face sides, is able to be delimited or is delimited in the inserted state.

If the step has a greater radial extent than the wall thickness of the fully circumferential guide region of the bushing, in which guide region the closing body is guided, the annular duct also has reduced throughflow resistance.

The annular duct has particularly reduced throughflow resistance if the step has a greater radial extent than the radial extent (thickness) of the reinforced webs.

In one exemplary embodiment of the 2/2 directional valve, two elongate holes are provided, and in another exemplary embodiment, three elongate holes are provided. At the bushing of the 3/3 directional valve, two groups of in each case two or three elongate holes distributed on the circumference may be provided. Consequently, in comparison with the prior art with four, six or even eight passage cutouts, the likelihood is reduced that one of the webs is situated exactly opposite an inflow duct of the valve block, which inflow duct opens from the outside, preferably radially, into the annular duct. If the insert valve according to the disclosure has been inserted into the valve block, in a relatively unfavorable case, only one of the webs is situated opposite the inflow duct, which web is furthermore also designed with a width in the circumferential direction of the bushing that is reduced in comparison with the prior art. Furthermore, there is a greater likelihood that no web is situated opposite the inflow duct, but that one of the elongate holes is situated opposite the inflow duct. Consequently, in all cases, the resistance of the flow from the inflow duct radially through the annular duct into one or at most two of the elongate holes is reduced.

It is particularly preferable if the elongate holes and/or the control cutouts of each group are distributed uniformly in a circumferential direction of the bushing or of the control slide.

On the face side of the bushing or of the further bushing, at least one marking, which simplifies the optimal orientation of the bushing, may be provided. Preferably the marking is introduced as a groove in the bushing directly centrally above the elongate hole.

The method according to the disclosure serves for making the elongate holes in the bushing of the above-described insert valve in a simple manner, and comprises the steps of:
preferably radially applying and inserting a drill or milling head, and
rotating the bushing about its longitudinal axis until the desired length of the elongate hole concerned is achieved.

### BRIEF DESCRIPTION OF THE DRAWINGS

Two exemplary embodiments of the insert valve according to the disclosure are illustrated in the figures.

In the figures:

FIG. 1 shows, in a longitudinal section, the 2/2 directional insert valve according to the disclosure according to an exemplary embodiment in a valve block,

FIG. 2 shows, in a cross section, the 2/2 directional insert valve according to the disclosure from FIG. 1 in the valve block,

FIG. 3 shows, in a perspective illustration, the 2/2 directional insert valve according to the disclosure from FIGS. 1 and 2,

FIG. 4 shows a bushing of the 2/2 directional insert valve according to the disclosure from the preceding figures,

FIG. 5 shows a longitudinal section the 3/3 directional insert valve according to the disclosure according to an exemplary embodiment, and

FIG. 6 shows, in a perspective illustration, the 3/3 directional insert valve according to the disclosure from FIG. 5.

### DETAILED DESCRIPTION

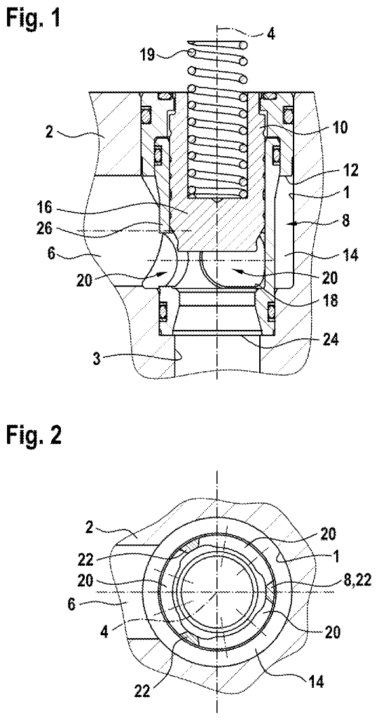

FIG. 1 shows, in a longitudinal section, the 2/2 directional insert valve according to the disclosure, which is in the form of a cartridge valve and is inserted into a corresponding cutout 1 of a valve block 2. Here, the cutout 1 and the insert valve and an outflow duct 3 of the valve block 2 extend along a common longitudinal axis 4. An inflow duct 6 is formed in the valve block 2 at right angles to the longitudinal axis 4.

The insert valve can be flowed through on both sides, that is to say the inflow and outflow ducts may also be swapped around in comparison with the exemplary embodiment described.

The insert valve has an inner bushing 8 and a further bushing 10, which are fastened to one another. Since the further bushing 10 has a greater outer diameter than the inner bushing 8, a radial step 12 is formed on the outside of the insert valve. The radial step 12 delimits at a face side an annular space or annular duct 14, which is furthermore formed between an outer lateral surface of the bushing 8 and the cutout 1 of the valve block 2. The inflow duct 6 opens into the annular duct 14.

In the interior of the bushing 8, a closing body 16 is guided along the longitudinal axis 4. When the closing body 16 is loaded (downwardly in FIG. 1) into a valve seat 18, formed on the inner circumference of the bushing 8, from its upper open position (shown in FIG. 1), for example by the force of a spring 19, said closing body closes off three elongate holes 20, of which only two are illustrated in FIG. 1.

FIG. 2 shows, in a cross section, the insert valve from FIG. 1, or more precisely the bushing 8 in the valve block 2. It can be seen that altogether three elongate holes 20 are provided on the circumference of the bushing 8, which elongate holes are separated from one another by a corresponding number of webs 22.

In the exemplary embodiment shown, the webs 22 take up only 20-25% of the outer circumference of the bushing 8. This consideration holds true for the section plane shown in FIG. 2, which (as viewed along the longitudinal axis 4 according to FIG. 1) extends at mid-height through the elongate holes 20.

In the open position, shown in FIG. 1, of the closing body 16, a pressure medium connection from the inflow duct 6, through the annular duct 14, through the three elongate holes 20, through the valve seat 18 and through a face-side opening 24 of the bushing 8, and finally to the outflow duct 3 has been opened up.

Provision is made for a reduction in the inner diameter of the bushing 8 between the valve seat 18 and the face-side opening 24.

Between the elongate holes 20 and that end portion of the bushing 8 which is opposite the face-side opening 24 and to which the further bushing 10 is fastened, the bushing 8 has a fully circumferential guide region 26, via which, substantially, the guidance of the closing body 16 along the longitudinal axis 4 is realized.

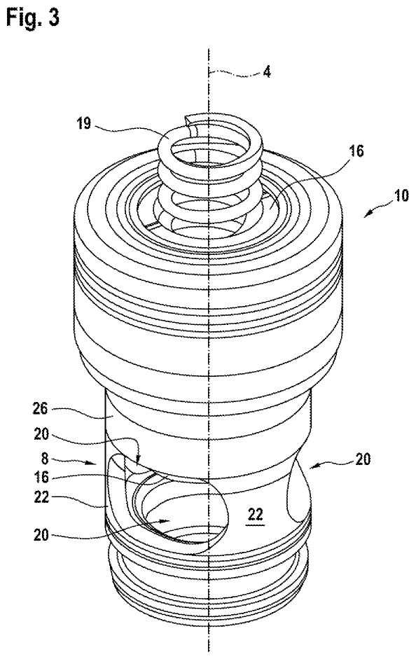

FIG. 3 shows, in a perspective illustration, the exemplary embodiment of the 2/2 directional insert valve according to the disclosure of the two preceding figures in isolation without the valve block 2. In particular the outer circumference of the bushing 8, which is surrounded by the annular duct 14 (not shown in FIG. 3), is illustrated. Illustrated above the bushing 8 in FIG. 3 is in particular the further bushing 10, into the interior of which an end portion of the closing body 16 is inserted. The spring 19 is in turn inserted into said end portion of the closing body 16.

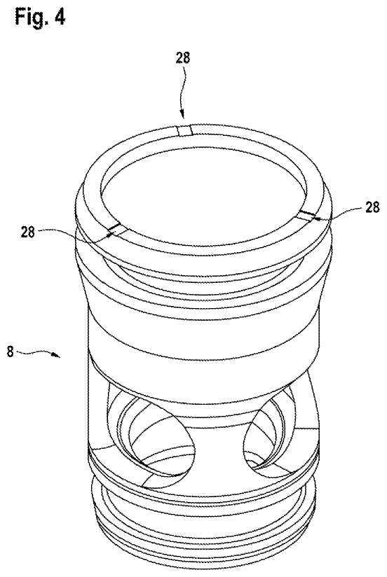

FIG. 4 shows the bushing 8 of the exemplary embodiment of the preceding figures in isolation. Three markings 28 in groove form are introduced on an upper face side of the bushing 8 and are each assigned to one of the three elongate holes 20. More precisely, a marking 28 is provided above each elongate hole 20, in each case centrally.

When inserting the 2/2 directional insert valve, one of the markings 28 and thus one of the elongate holes 20 of the bushing 8 can then be optimally oriented with respect to the inflow duct 6.

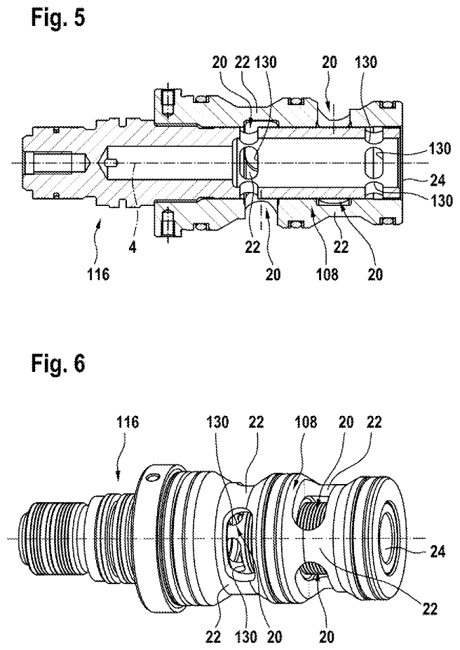

FIG. 5 shows, in a longitudinal section, and FIG. 6 shows, in a perspective view, the 3/3 directional insert valve according to the disclosure according to an exemplary embodiment. Said insert valve has a one-piece bushing 108 of cartridge design, which is stepped on the outer circumference and can be inserted into a corresponding cutout of a valve block. Two annular ducts which are axially spaced apart from one another and are sealed with respect to one another are consequently formed at the outer circumference of the bushing 108.

In the interior of the bushing 108, a control slide 116 is guided along the longitudinal axis 4.

Two groups of in each case three elongate holes 20 are provided on the circumference of the bushing 8, which elongate holes are distributed uniformly on the circumference and are separated from one another by a corresponding number of webs 22.

It can furthermore be seen that two groups of in each case four control cutouts 130 are provided on the circumference of the control slide 116, which control cutouts are distributed uniformly on the circumference and are separated from one another by a corresponding number of webs.

In the position of the control slide 116 shown in FIGS. 5 and 6, a pressure medium connection from the first annular duct (on the left in the figures), through the three elongate holes 20 of the first group of the bushing 108, through the four control cutouts 130 of the first group of the control slide 116, through the interior of the control slide 116, and through a face-side opening 24 of the bushing 8 is present.

Starting at the position of the control slide 116 shown in FIGS. 5 and 6, the latter can be displaced to the left, which makes possible a pressure medium connection from the second annular duct (on the right in the figures), through the three elongate holes 20 of the second group of the bushing 108, through the four control cutouts 130 of the second group of the control slide 116, through the interior of the control slide 116, and through the face-side opening 24 of the bushing 8. At the same time, the previously mentioned pressure medium connection is closed.

What is disclosed is an insert valve having a bushing 8; 108 which has, as a pressure medium passage, holes distributed on the circumference or which has, as pressure medium passages, two groups of holes distributed on the circumference. Via the holes and an interior of the bushing 8; 108, an annular duct 14 at the outer circumference of the bushing 8 is able to be connected to a port 24 on a face side of the bushing 8, or two annular ducts at the outer circumference of the bushing 108 are able to be connected to the port 24 on the face side of the bushing 8. The holes are able to be closed off by a displaceable closing body 16; 116. For the purpose of minimizing the throughflow resistance, the holes, in comparison with the prior art, are enlarged in a circumferential direction and are formed as elongate holes 20.

What is claimed is:

1. A directional insert valve, comprising:
a closing body; and
a bushing in which the closing body is movable, wherein first passage cutouts are arranged distributed in a circumferential direction of the bushing, wherein the first passage cutouts are first elongate holes that are larger in the circumferential direction of the bushing than in an axial direction of the bushing, and wherein the directional insert valve is a 2/2 directional insert valve or a 3/3 directional insert valve.

2. The directional insert valve according to claim 1, wherein the directional insert valve is a 3/3 directional insert valve, wherein the closing body is a control slide, wherein second passage cutouts are arranged distributed in the circumferential direction of the bushing and are axially spaced apart from the first passage cutouts, and wherein the second passage cutouts are second elongate holes that are larger in the circumferential direction of the bushing than in the axial direction of the bushing.

3. The directional insert valve according to claim 2, wherein first control cutouts of a first group and, axially spaced apart therefrom, second control cutouts of a second group are (i) arranged distributed on the control slide, (ii) at least sectionally, configured to be brought into overlap with the first and second elongate holes of the bushing, (iii) and further elongate holes that are larger in a circumferential direction of the control slide than in an axial direction of the control slide.

4. The directional insert valve according to claim 1, further comprising webs arranged between the first elongate holes, the webs reinforced in a radial direction.

5. The directional insert valve according to claim 1, wherein the directional insert valve is a 2/2 directional insert valve configured as a seat valve, and wherein the bushing has on the inner circumference a valve seat for the closing body.

6. The directional insert valve according to claim 5, wherein an inner diameter of the bushing is configured to have a reduction disposed between the valve seat and a face-side opening of the bushing.

7. The directional insert valve according to claim 1, wherein, as viewed in the circumferential direction, the first elongate holes extend over at least 75% of the outer circumference of the bushing.

8. The directional insert valve according to claim 1, wherein the directional insert valve is a 2/2 directional insert valve, wherein (i) the bushing has a radial step on an outer circumference thereof or (ii) a further bushing of the directional insert valve forms a radial step with the bushing, and wherein an annular duct is configured to be delimited by the radial step.

9. The directional insert valve according to claim 8, wherein one or more of (i) the radial step has a greater radial extent than a wall thickness of a fully circumferential guide region of the bushing, the closing body guided in the guide region and (ii) the radial step has a greater radial extent than the wall thickness of the bushing in the region of the first elongate holes.

10. The directional insert valve according to claim 8, further comprising webs arranged between the first elongate holes, wherein the webs are reinforced in a radial direction, and wherein the radial step has a greater radial extent than the radial extent of the reinforced webs.

11. The directional insert valve according to claim 1, wherein the directional insert valve is a 2/2 directional insert valve, and wherein a number of the first elongate holes is two or three.

12. The directional insert valve according to claim 2, wherein the bushing has a total of six first and second elongate holes.

13. The directional insert valve according to claim 1, wherein, on a face side of the bushing, a marking corresponds to at least one first elongate hole.

14. A method for making elongate holes in a bushing of a 2/2 directional insert valve or a 3/3 directional insert valve, comprising:
applying and inserting a drill or milling head; and
rotating the bushing about a longitudinal axis thereof to form a plurality of passage cutouts arranged distributed in a circumferential direction of the bushing, the passage cutouts defining the elongate holes, which are larger in the circumferential direction of the bushing than in an axial direction of the bushing.
